(19) United States
(12) Patent Application Publication
(10) Pub. No.: US 2015/0084547 A1
(43) Pub. Date: Mar. 26, 2015

(54) DALI commissioning tools and methods for implementing

(71) Applicant: Verified Energy, LLC, Rochester, NY (US)

(72) Inventors: Thomas I. Yeh, Rochester, NY (US); David W. Sheehan, Glenville, NY (US)

(73) Assignee: Verified Energy, LLC, Rochester, NY (US)

(21) Appl. No.: 14/038,676

(22) Filed: Sep. 26, 2013

(51) Int. Cl. H05B 37/02; H04L 29/08; H04L 29/12

(52) U.S. Cl. CPC H05B 37/0272; H05B 37/0254; H04L 61/2038; H04L 67/12
USPC 315/312

(57) ABSTRACT

The present invention provides for a system that: automatically detects new DALI ballasts that join a lighting network, automatically detects sensor inputs on devices that reside on a lighting network, automatically configures the DALI short addresses on a DALI devices on the lighting network to ensure each ballast and device is uniquely addressed, automatically sets configuration parameters on a newly detected DALI ballast or whenever the DALI controller or lighting network manager role globally adjusts ballast configuration, and masquerades non-DALI ballasts as a native DALI ballast such that they can be integrated into a DALI lighting system transparently.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provide for by the terms of DOE Cooperative Agreement DE-EE0003971 CFDA No. 81.086 awarded by the Department of Energy.

This non-provisional patent application is being filed by Thomas I. Yeh of Rochester, N.Y. and David W. Sheehan of Glenville, N.Y.

### TECHNICAL FIELD

The current invention relates to lighting control systems for homes, offices, commercial spaces, parking, exterior perimeter and public areas; more particularly to incorporating wireless networks into the lighting control systems; more particularly to lighting control systems using digitally addressable lighting interface (DALI) command protocol; more particularly to initializing lighting control systems.

### BACKGROUND OF THE INVENTION

Centrally controlled lighting systems for homes, offices, commercial spaces, and public areas are well known in the art. One such control system is known as digital addressable lighting interface (DALI). DALI is a digital protocol for lighting control devices. DALI's two-wire physical network is a data bus connecting up to 64 DALI lighting control devices, such as ballasts, occupancy sensors, photo sensors and switch panels, to one DALI controller via physical and electrical connections termed as “ports”. Ports are physical and electrical connections for the DALI Controller and control devices to inter-connect. The DALI controller may be a central computer or other intelligent control unit.

Standards for DALI protocol such as National Electronics Manufacturers Association LSD 53-2010 in the United States and DALI Manual by ZVEI-Division Luminaires of Frankfurt Germany are well known in the Art.

In a wired implementation, a single DALI two-wire physical network is referred to as a “stream.” A stream may contain just a single DALI control device or as many as 64 DALI control devices, in addition to the stream's DALI Controller. Each DALI stream is limited to one DALI Controller serving as the Bus Master initiating all DALI commands. Each of the DALI control devices is assigned a unique address.

In FIG. 1 a simplified typical wired implementation of a DALI control system 100 is depicted. As those skilled in the art are aware, a DALI stream is defined as at least one DALI controller 110 and at least one controlled device 210 interconnected by a bus 120 made of two wires. To improve the noise immunity of the bus 120 the two wires are frequently deployed as a twisted pair.

DALI controllers and controlled devices may be connected as a star or (more commonly) may be daisy chained. The DALI specification provides for up to 64 controlled devices (ballasts, switches, sensors, etc.) to be connected to a common twisted pair bus. The bus 120 also requires a DC voltage, which may be physically provided as a standalone power supply 130 or the power supply function may be integrated into the physical package of a DALI controller or controlled device. Only one power supply is allowed.

Consequently, a DALI stream is one or more DALI controllers connected to a common twisted pair bus with up to 64 DALI controlled devices. The stream is energized by a DC voltage provided by a standalone power supply or by a DALI device connected to the stream.

One DALI controller 110 with a DALI port is connected to one DALI stream consisting of at least a single DALI controlled device 210 via a wired data bus 120. A DALI controlled device 210 is typically a DALI controllable ballast in a DALI controllable network but as those skilled in the art are aware, the DALI specification (NEMA LSD 53-2010) includes additional controlled device types, such as switch device, slide dimmer, motion (occupancy) sensor, scheduler, gateways, to name a few. The DALI specification also allows for multiple DALI controllers initiating DALI commands (both commands requiring no response and commands (also known as query commands or queries) requiring a response from the controlled devices) to the controlled devices connected on the same stream as the controllers. The terms “query” and “query command” as used herein are interchangeable and refer to a command that receives data from a controlled device either through a response containing data received from the controlled device or through the absence of a response in the case of certain queries.

In a wired implementation, a single stream and a DALI port has a one to one correspondence. One DALI port is also physically a single DALI stream formed by the two communications wires emanating and connecting all the DALI controlled devices on the stream. A ballast may be wired to a lamp 220 or a bank of lamps.

DALI protocol by specification is designed to transmit data at 1,200 cycles per second (Hertz (Hz)), plus or minus 10 percent. The time duration of each cycle is nominally equal to 833.33 microseconds.

A DALI forward frame is defined as a command transmitted from the DALI controller and contains an address byte and one or two data bytes.

A 2-bytes DALI forward frame, consisting of one address byte and a data byte, has 19-bits of data. A 3-bytes DALI forward frame, consisting of one address byte and two data bytes, has 27-bits of data.

A DALI back frame, defined as a reply responding to the immediate forward frame, consists of 11-bits of data.

DALI protocol employs Manchester encoding for serial data transmission. Manchester encoding requires two sampling intervals to decode a single data bit. DALI protocol refers to each sampling interval as “TE”. The duration of each TE is one half of 833.33 microseconds.

Standards for DALI protocol such as NEMA LSD 53-2010 in the United States and DALI Manual by ZVEI-Division Luminaires of Frankfurt Germany have identified reserved elements of the protocol for future expansion and for manufacturer specific extensions. A reserved element or a manufacturing specific extension element of the DALI protocol may be used as a special command within the current DALI specification. The original DALI specification based on 2-byte commands only supports reserved commands, which in theory should not be used for manufacturer extensions, although it is rather common for manufacturers to use reserved commands for their specific extensions. In the more current DALI specification such as the NEMA document the element of manufacturer specific commands are explicitly identified separately from the reserved commands.

In a DALI control system, the DALI controller 110 is frequently sending commands and queries to the DALI controlled devices 210 to ensure optimal operation of the DALI controlled devices 210. The DALI specification maintains a 22 TE maximum limit for each DALI controlled device 210 to respond to the DALI controller 110 for DALI commands requiring a response. This maximum limit of 9.16667 milliseconds is encoded into the protocol and is required of each DALI controlled device 210 when responding to the DALI controller 110.

There are many reasons why implementation using a wireless network would be desired, including simplifying building renovation and reduced installation expense by elimination of problematic communication wiring (i.e. long run communication wiring). A significant shortcoming of wireless network based implementations (e.g. implementing ZigBee protocol) is that the communications between devices cannot be guaranteed to occur within the DALI specification's maximum response time. The timing requirements of the DALI protocol are designed for a communication media where a DALI controller and the connected DALI stream is hardwired in a fashion that the delays or latency introduced by the media are near zero. This makes DALI incompatible with wireless communication media, where latency is non-deterministic and varies greatly depending on real-time network conditions, and can exceed the timing requirements of the DALI protocol. This is problematic for DALI configuration and special commands where the commands must be repeated within a specified timeframe as received by the DALI controlled device on the connected stream or it will be ignored. For DALI query commands, the protocol specifies a very short timing requirement for the responding DALI back frame (e.g. “data”) such that it is unreliable for most wireless networking schemes, especially a wireless network with low to moderate data rate such as ZigBee Alliance's IEEE 802 based high level communication protocols standard for personal area networks (PANs), to maintain compatibility with the DALI protocol. A DALI controlled device must begin transmitting a response to a DALI controller within 22TE (about 9.17 ms). In the case of certain DALI commands such as number 146, query lamp failure, the lack of a response from a control device is interpreted as a valid result and has a specific meaning and thus any lack of response by a control device must be intentional in order to ensure the proper interpretation of the control device state by the DALI controller. Any processing overhead to encode/decode a wireless signal (which is non-zero) plus the wireless transmission itself makes adherence to this difficult and resulting in the controller obtaining a false state of the control device parameter. With a protocol like ZigBee, it is typical to take at least 10-15 ms per communication hop through the network, which breaks this 22TE response transmission initiation requirement immediately. As those skilled in the art are aware, in Zigbee a communication transmission may be relayed through multiple devices; each transmission between devices is referred to as a hop. Each communication transmission is termed a cluster; each ZigBee cluster, defined by a 16-bit identifier, contains both a command and at least one attribute where each command causes an action and each attribute tracks the current state of an element of the cluster (e.g., a level control cluster command can tell a ballast to adjust the intensity of a light and an attribute tracks the intensity of the light).

In PCT patent application PCT/US2012/048340, Yeh and Sheehan present a system and method to transport DALI protocol via an intermediate communication protocol such as a wireless network before converting back to the wired DALI data bus to complete a lighting control application.

The present invention streamlines the commissioning of a DALI controller system and significantly reduces the labor required to commission a DALI controller system. The invention works in systems where intermediary communications are transmitted via wired configurations such as a typical DALI system and also wireless configurations. Ballasts and other devices can be added to the system and the master DALI controller can automatically recognize and control the new ballasts. The address of sensors and other devices can also be automatically detected by the system. This goes beyond the current state of the art.

In a standard DALI lighting network in ongoing operation, the DALI bus is heavily loaded running commands required for proper operation of the system. If a new ballast or device is introduced, it can often take several minutes or longer to configure it as doing so more rapidly would require bandwidth being used for critical user noticeable operations being deferred. The present invention enables the new ballast or device to be added more rapidly to the network.

The present invention provides a method of auto configuration to ensure that all devices are configured as desired very rapidly after provisioning without any loading or impact to other operations on the network.

The typical DALI ballast comes pre-programmed with an address. The address is typically printed on a label on the device, which will not typically be observable after the ballast has been installed. It is difficult and time consuming to incorporate this address into the DALI control system. The present invention provides a method for the lighting system in general, and DALI controller in particular, to see the address.

The assigned DALI address is supposed to be unique on a DALI stream according to DALI specifications; and it gets assigned parameters to be compatible with the other lights in the stream. Fade time, max and min light level, etc. The parameters for a particular light will automatically be determined on where the light resides. (Room 1 or Room 2).

In a traditional DALI lighting network, only DALI enabled ballasts can be connected to the bus. With the DALI Masquerade invention, Slave Modules can allow any dimmable lighting ballast or driver that can be physically connected to the module to behave like a DALI ballast. If a ballast is added that isn't a DALI ballast (such as a 0-10 V ballast), this system can make it work as if it was a DALI ballast. Alternatively, one would have to make sure the pre-addressed ballast is installed into a particular room or area of the stream determined during design. If the ballast was put in the wrong place, it would have to be either swapped to the right one or reprogrammed to act like the ones around it.

Unique to our system is not only the ability to automatically detect a sensor but to also provision the sensor on the master module.

Though the examples of the present invention in this document are directed to DALI controllers, it should be obvious to those skilled in the art that the methods described may be used with any lighting system controlling device.

### SUMMARY OF THE INVENTION

The present invention provides for a system that:

1. automatically detects new DALI ballasts that join a lighting network,
2. automatically detects sensor inputs on devices that reside on a lighting network,
3. automatically configures the DALI short addresses on DALI devices on the lighting network to ensure each ballast and device is uniquely addressed,
4. automatically sets configuration parameters on a newly detected DALI ballast or whenever the DALI controller or lighting network manager role globally adjusts ballast configuration, and
5. masquerades non-DALI ballasts as a native DALI ballast such that they can be integrated into a DALI lighting system transparently.

### DEFINITIONS OF TERMS USED IN THIS SPECIFICATION

As used in this application, a DALI slave device is a ballast or other device on a DALI network that is assigned a short address and responds to commands sent from a DALI controller.

As used in this application, a DALI controller is a device on a DALI network that sends commands or queries to DALI slave devices.

As used in this application, a slave module is a module or device that is attached to one or more DALI slave devices that facilitates address assignment and configuration with the master module.

As used in this application, a master module (or master controller, used interchangeably) is a module or device that facilitates addressing and configuration of DALI slave devices. This module communicates bi-directionally with the slave module and maintains centralized state of the DALI slave devices on the network.

As used in this application, a sensor is any data source or element that provides information about an externality in the system to an upstream control device. Common sensors in a lighting network include but are not limited to occupancy sensors and photo sensors.

The present invention can also be deployed beyond lighting control to other building systems, such as heating, air conditioning and ventilation systems.

### BRIEF DESCRIPTION OF FIGURES

Embodiments of the present invention will be described by reference to the following drawings, in which like numerals refer to like elements, and in which:

FIG. 1 depicts a hard wired lighting system using a DALI interface;

FIG. 2 depicts an exemplary wireless lighting system using a DALI interface;

FIG. 3 depicts a chart of a representative example of master module logic flow when an address request message is received from a slave module;

FIG. 4 depicts a chart of a representative example of master module logic flow when an address confirmation message is received from a slave module;

FIG. 5 depicts a chart of a representative example of master module logic flow during an event loop;

FIG. 6 depicts a chart of a representative example of slave module logic flow when a slave device is discovered;

FIG. 7 depicts a chart of a representative example of slave module logic flow when an address response message is received from the master module;

FIG. 8 depicts a chart of a representative example of slave module logic flow when a confirmation message is received from the master module;

FIG. 9 depicts a high level sequence diagram; and

FIGS. 10-15 each depict an exemplary wireless lighting system with a single DALI controller controlling multiple streams.

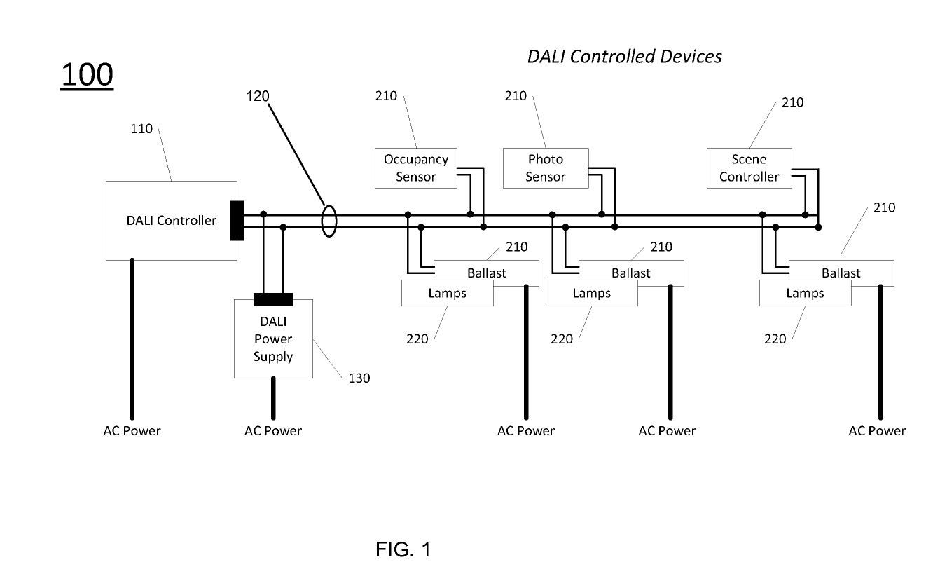

### DETAILED DESCRIPTION OF THE INVENTION

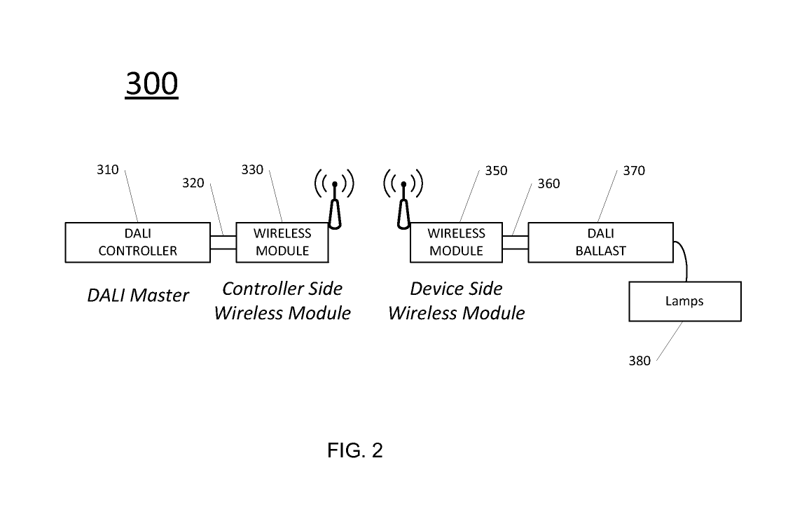

Referring to FIG. 2 a preferred embodiment of an exemplary lighting control system 300 is depicted. A DALI controller 310 is connected via a first two wire data bus 320 (e.g. a twisted pair wire) to a master module 330. The master module 330 communicates via either a wired or a wireless communication protocol to slave modules 350. For ease of narrative the wireless communication protocol in this representative example will be the ZigBee communication protocol. Other wireless communication protocols may be utilized. Each slave module 350 is connected via a second two wire data bus 360 to at least one DALI stream comprising at least one DALI slave device 370 which is connected to at least one lamp bank 380 (not depicted). To simplify the description, the term “slave device” will refer to any “peripheral device” that may be used in a DALI stream and the two terms may be used interchangeably along with the term “controlled device”. As those skilled in the art are well aware these peripheral devices may include, but are not limited to, ballasts, sensors, dimmer switches, timers, and the like. A DC power supply, not shown, may be integrated with the DALI controller 310 or may be provided separately to the DALI controller 310. A separate DC power supply, also not shown, may be integrated with each slave module 350 or may be provided separately to each. Yeh and Sheehan disclose a method to encapsulate DALI commands in wireless networks in a patent cooperation treaty application (PCT/US/12/48340) which is hereby incorporated by reference in its entirety. The master module 330 and the slave module 350 each comprise a set of software components that encode and decode the DALI protocol and preferably handle data encapsulation over an intermediate wireless medium while maintaining a reference to the DALI stream the traffic originated from and is destined to arrive and which provide for the seamless control of each lamp bank 380 by the DALI controller 310 even though the DALI controller 310 is not hard wired directly to DALI ballasts 370. It should be obvious to those skilled in the art that in other embodiments of the present invention that the DALI controller 310 may be wired directly to additional ballasts provided the DALI controller 310 does not perceive more than 64 non-grouped ballasts on a single stream and also that the presence of DALI streams hardwired to a DALI controller does not preclude the novelty of the present invention.

### DALI Device States

Each DALI slave device can be in one of several states on each of the master module and slave modules. While the state of the DALI slave device on each of the master and slave modules may differ, they are interrelated as described in this section. The state of the DALI slave device in no way impacts the actual DALI operation of the slave device and the slave device has no knowledge of these high-level states.

### DALI Device States on the Master Module

On the master module, each DALI slave device will be assigned a device status. The master module will assign the DALI slave device status based upon what communications it has had with each slave device. These statuses are pending, approved, and pending delete.

A DALI slave device status on the master module is termed to be pending when the master module has assigned a new DALI short address to the DALI slave device and is awaiting confirmation from the slave module that the address has actually been changed on the underlying DALI slave device.

A DALI slave device is assigned pending status on the master module when the slave module sends the master module an address request message and the requested address is unavailable. The master module will assign a new address to the DALI slave device and will inform the slave module of the new address. The master module will assign the status of pending to the new address.

A DALI slave device status on the master module is termed to be approved when the master module has received confirmation from the slave module that the address has been changed on the underlying DALI slave device. This is the typical operational state for a connected and communicating DALI slave address on the network. In this case, the master module has approved the short address the DALI slave device is utilizing.

A DALI slave device is assigned approved status on the master module when either a DALI slave device address in the pending state has been confirmed via a response from the appropriate slave module or when a slave module sends an initial address request to the master module and the master module is able to directly approve the address request. The master module is able to directly approve an address request when the address request does not incur a short address conflict between the DALI slave device and other slave devices in the DALI system.

A DALI slave device status on the master module is termed to be pending delete when the master device has lost communication with the slave module attached to the DALI slave device or the DALI slave device is no longer communicating. During this state, the master module and overall system behaves as if the DALI slave device is in the approved state. Provided there is no call for additional slave devices to be added to the system, the operation of the master module and overall system regarding the DALI slave device is identical in either state (approved or pending delete). However, an address in the pending delete state will be reused if required by the system (e.g.: either a new slave device connects with an address that duplicates the pending delete device and is thus approved; or the master module deletes the pending delete entry if additional memory is required for additional DALI slave devices) and the DALI slave device that had been in the pending delete state will be deleted.

A DALI slave device is assigned pending delete status on the master module when the DALI slave device's address becomes unresponsive for a predetermined time period.

A DALI slave device with a pending status will remain in the pending state until one of two events occurs. If the slave module confirms that the DALI slave device address has been correctly changed, then the master module will change the status to approved. If the slave module does not confirm the DALI slave device address and repeated attempts to contact the slave module have been unsuccessful, then the DALI slave device status will be updated to pending delete.

A DALI slave device with an approved status will remain in the approved state until one of three events occurs. If the DALI slave device becomes unresponsive for a configured period of time, in which case the DALI slave device status is revised to pending delete. If the slave module associated with the DALI slave device reports that the DALI slave device is no longer present, then the DALI slave device status is revised to pending delete. If the slave module associated with the DALI slave device no longer exists in the DALI system then the DALI slave device status is revised to pending delete.

A DALI slave device with a pending delete status will remain in the pending delete state until one of four events occurs. If the DALI slave device reconnects to the DALI system, then the status will be reset to approved. If there is a need on the master module memory to free up an address slot to connect a new ballast then the DALI slave device address is deleted and thus if the DALI slave address reconnects, it would proceed through the standard event sequence as if it were a new and unknown DALI slave device. Preferably, if the master module is rebooted; the DALI slave device address is deleted. However by not deleting the DALI slave device address upon reboot is in no way circumventing the novelty of this invention. If configured to delete DALI slave device addresses after their status has been pending delete for a predetermined time period, then the master module will delete the DALI slave device address upon reaching the predetermined time period.

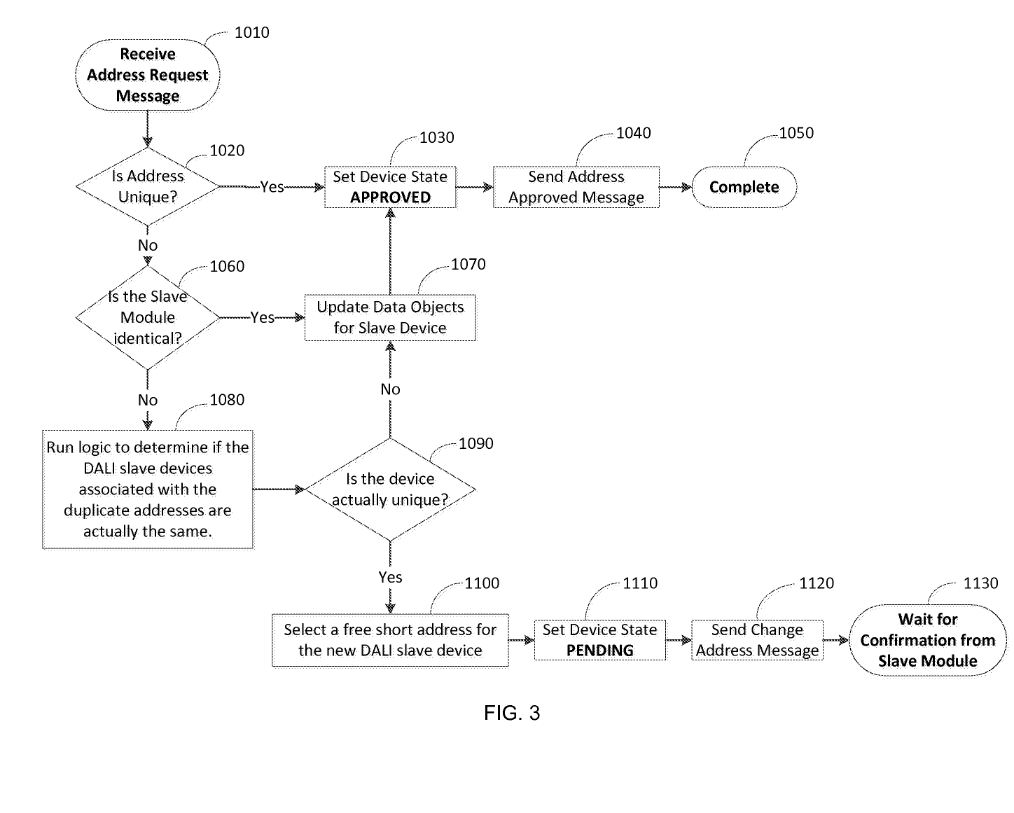

FIG. 3 depicts a flowchart of a preferred embodiment of the present invention of the logic used by the system when a slave module requests an address. In step 1010 a slave module receives a back frame from a controlled device and detects that the controlled device is unknown. The slave module sends a back frame containing a non-DALI message which is a request for an address from the slave module, which is passed upstream to a DALI master controller. In step 1020, the DALI controller determines whether the address is unique. If the address is unique, in step 1040 the device status is set to approved in step 1030 and the DALI controller issues a message to the slave module indicating that the address is approved. If, in step 1020, the address is not unique then proceed to step 1060. In step 1060, it is determined whether the slave module with the pending address approval is identical to the slave module which currently has the assigned the address for one of its slave device. If the slave modules are identical then in step 1070 the data objects in the data table are updated for the requesting controlled device and proceed on to step 1030. In steps 1080 and 1090, if the slave module requesting with the address is not identical to the slave module currently assigned the address, then the DALI controller determines whether the slave device with the same addresses are in fact the same device. If the slave devices are actually the same devices, then the data objects for the slave module connected to the slave device are updated in step 1070. If the slave devices are actually unique devices, then the new controlled device is assigned a new available short address in step 1100. The status of the new controlled device is set to ‘pending’ in step 1110. In step 1120, the DALI controller sends a change address message to the slave module. In step 1130, the DALI controller waits to receive confirmation from the slave module that the address has been changed.

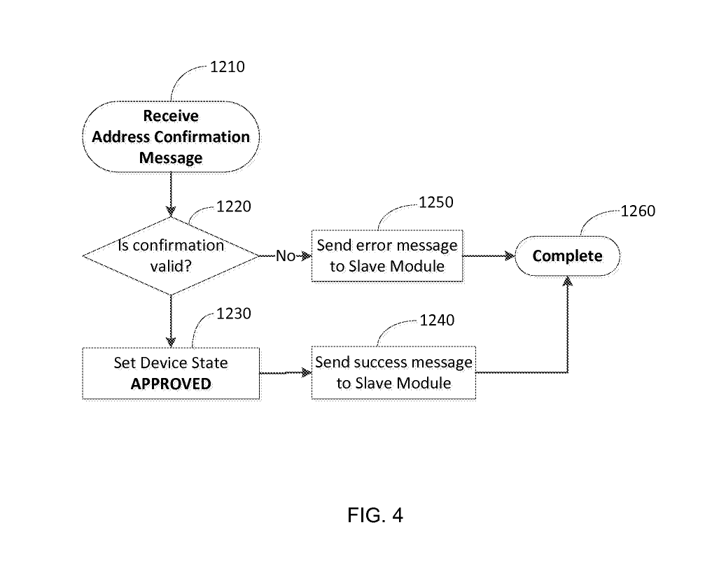

FIG. 4 depicts a flowchart of a preferred embodiment of the present invention of the logic used by the system when a slave module sends an address confirmation request.

In step 1210 a slave module receives a back frame from a controlled device containing a confirmation message that an address was received by the controlled device. The slave module sends a back frame containing a non-DALI message which is a confirmation message that the address was received from the slave module to the DALI master controller. In step 1220, the DALI controller verifies whether the confirmation is valid. If the confirmation is not valid, the DALI controller sends an error message to the slave module in step 1250. If, in step 1220 the confirmation is determined to be valid, the DALI controller updates the data table and sets the controlled device state to approved in step 1230. In step 1240, the DALI controller sends a message to the slave module indicating that the address confirmation message was successfully received by the DALI controller. The address confirmation message received logic is terminated in step 1260.

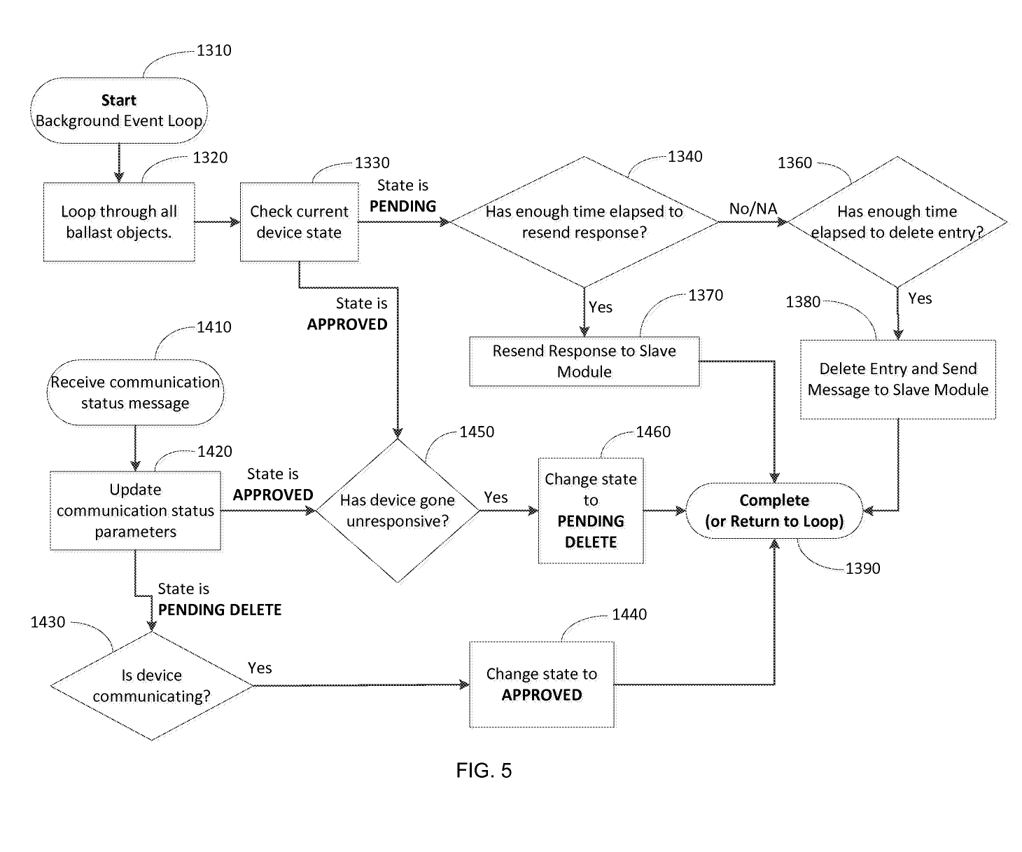

FIG. 5 depicts a flowchart of a preferred embodiment of the present invention of the logic used by the system to determine communication status of slave modules. Status updates for the slave modules may originate from either a slave module originating a communication status message or from a DALI controller or master module requesting status updates from each slave module.

In steps 1310, 1320 and 1330, the master module polls the DALI slave devices requesting the current status of each device. If the check in step 1330 indicates that device status is pending then in step 1340 the master controller determines if enough time has elapsed to resend the response. If enough time has not elapsed, go to step 1360 and proceed to step 1380 where the entry is deleted and a message is sent to the slave module. If, in step 1340, enough time has elapsed to resend the response to the slave module then the response is resent to the slave module in step 1370. Referring again to step 1330, if the current device status is approved then determine whether the device has gone unresponsive (step 1450). If it has gone unresponsive, then the state is changed to pending delete in step 1460. If the device has not gone unresponsive, then the process is complete.

Upon receipt of a communication status message from a slave module, step 1410, the master module will update the communication status parameters in step 1420 dependent upon the slave device state. If the DALI slave device state is approved, then step 1450 is initiated and the master device determines if the device has gone unresponsive.

If in step 1420, the state is pending delete, the master device determines whether the device is communicating. If it is communicating, the state is changed to approved. If it is not communicating, the state remains pending delete.

### DALI Slave Device State on the Slave Module

On a slave module, each DALI slave device will be assigned a device status. The slave module will assign the DALI slave device status based upon what communications it has had with each DALI slave device. In a preferred embodiment of the present invention, these statuses are init, request sent, readdress start, readdress complete, and approved.

A DALI slave device status on the slave module is termed to be init after the slave module has discovered a DALI slave device but before autoaddressing and configuration of the DALI slave device has begun.

A DALI slave device is assigned init status on the slave module when the device is discovered but prior to any auto addressing processing initiating.

A DALI slave device status on the slave module is termed to be request sent when the slave module sends a request to the master module requesting approval to utilize the DALI short address for the specified device. All slave devices must go through this state prior to being approved.

A DALI slave device is assigned request sent status on the slave module when an address request message has been sent by the slave module to the master module for the DALI slave device.

A DALI slave device status on the slave module is termed to be readdress start when the response from the master module to a request sent by the slave module indicates that the DALI slave device address must be changed. (i.e., another slave device is already assigned the address requested.) The readdress start state indicates that the DALI slave device is currently being readdressed by the underlying DALI driver component.

A DALI slave device is assigned readdress start status on the slave module when the master module has indicated that the DALI slave device address must be changed and the slave module has begun the process of changing the DALI slave device address.

A DALI slave device status on the slave module is termed to be readdress complete after the DALI slave device status has been readdress start and the associated DALI slave module has completed the short address change. At this point the slave module notifies the master module that the operation is complete.

A DALI slave device is assigned readdress complete status on the slave module when the slave module has confirmed that the DALI slave device address has been changed successfully on the DALI slave device. When the DALI slave device enters readdress complete status, the slave module sends a status confirmation to the master module.

A DALI slave device status on the slave module is termed to be approved when the master module notifies the slave module that the address has been approved. This can occur directly from either the request sent state or the readdress complete state.

A DALI slave device is assigned approved status on the slave module when the slave module receives a message from the master module indicating that the address confirmation process is complete and the master module has approved the DALI slave device address. This step allows the system to work correctly without time sync between the slave and master modules as it prevents issues from arising if the slave module is powered down for a period of time during which the master module expires the request and re-assigns the same address to another module that comes online.

A DALI slave device with an init status will remain in the init state until the slave module begins processing the new DALI slave device. Upon initiating processing, the DALI slave module will send an address request message to the master module which initiates the slave device entering the request sent state.

A DALI slave device with a request sent status will remain in the request sent state until the master module has responded to the address request. The master module response will take one of the following three forms. The master module can approve the request which will transition the DALI slave device address status to approved. The master module can decline the request or request an address change in which case the slave module will program a new address on the DALI slave device and the DALI slave device address state will transition to the readdress start state. The master module may not respond to the address request or an error condition may occur; if either of these occur the slave module will resend the address request message to the master module.

A DALI slave device with a readdress start status will remain in the readdress start state until the slave module DALI short address has successfully been changed. Upon successful completion of the DALI slave device address change, the DALI slave device address state enters the readdress complete state.

A DALI slave device with a readdress complete status will remain in the readdress complete state until the master module has responded to the slave module indicating that the process is complete and that the DALI slave address is now in the approved state.

A DALI slave device with an approved status will remain in the approved state unless the master module requests the slave modules to re-request addresses for each DALI slave device. If this request is received, the discovered DALI slave device statuses revert back to the init state. While such a request will be uncommon, it could occur if the master module is reset, if power is lost to the master module and in instances of the like.

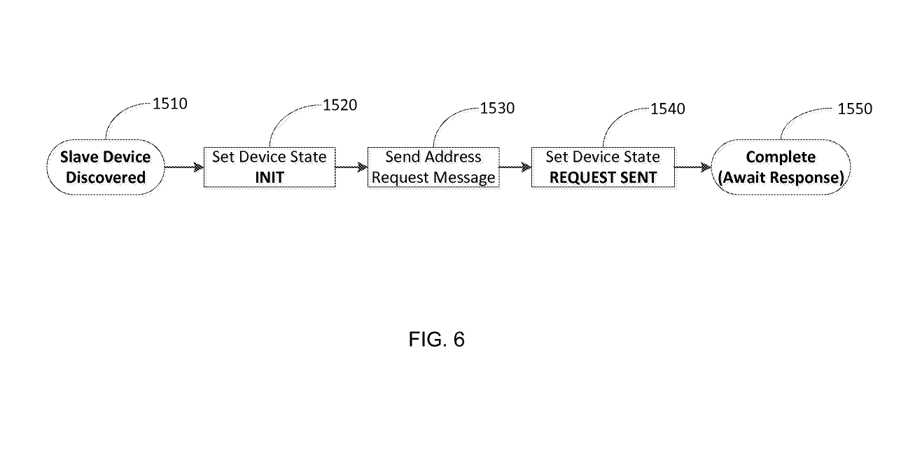

In FIG. 6 the logic followed upon discovery of a slave module is described. In step 1510 a DALI slave device is discovered. In step 1520, the device state is set to init. In step 1530 the DALI slave device requests an address from the master module. In step 1540 the DALI slave device state is updated to request sent. In step 1550 the DALI slave device awaits a response from the master module.

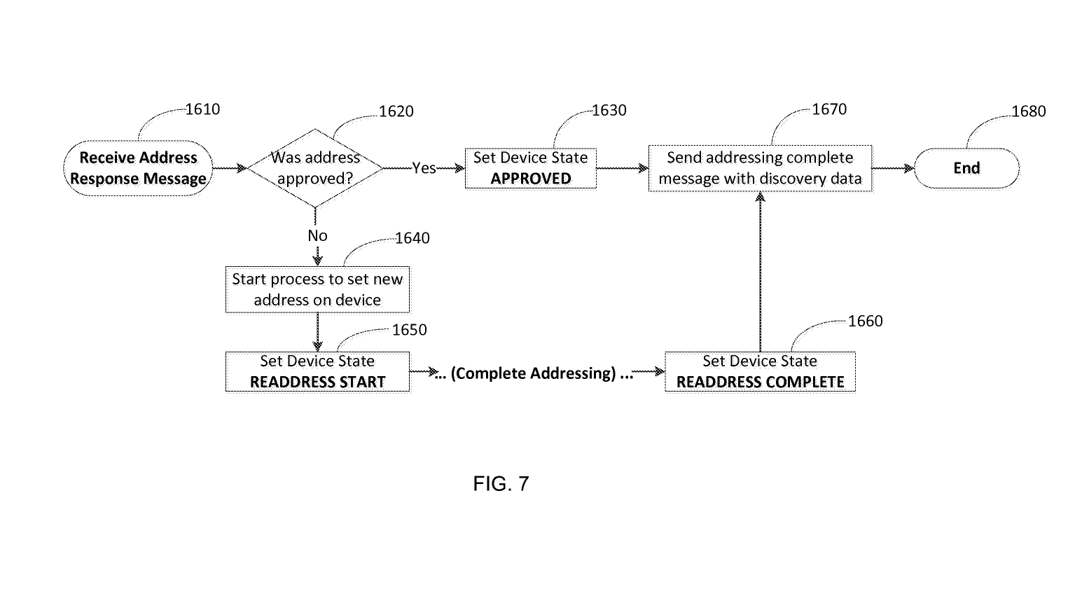

FIG. 7 depicts the logic followed by the slave module upon receipt of a response from the master module. In step 1610 an address response message is received by the DALI slave device. In step 1620 the DALI slave device determines if the master module provide an address. If the address was approved then the DALI slave device status is set to approved in step 1630. If the address was not approved in step 1620 then in step 1640 the process to set a new address on the DALI slave device is initiated. In step 1650 the DALI slave device is set to readdress start and the addressing is completed. In step 1660 the device state is set to readdress complete. In step 1670 an addressing complete message with discovery data is sent to the master module.

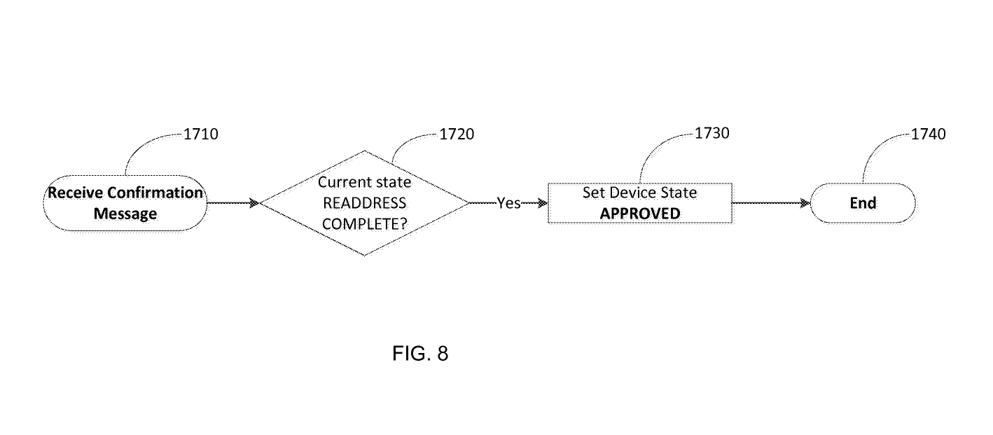

FIG. 8 depicts the logic followed by the slave module upon receipt of a response from the master module. In step 1710 a confirmation message is received by the DALI slave device. In step 1720 the DALI slave device determines if the readdress is complete. If the readdress is complete then the slave device is set to approved in step 1730. If the address was not approved in step 1720 then in step 1740 another request is sent to the master module.

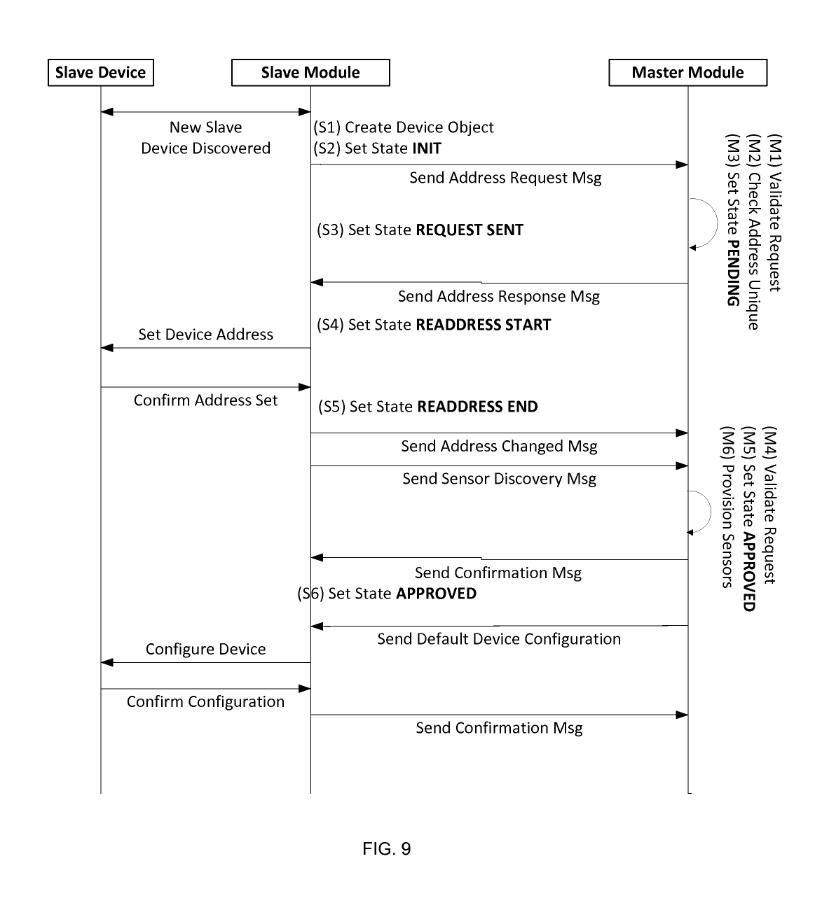

FIG. 9 depicts a representative example of the high level sequence of events between a slave device, a slave module, and a master module for the case where a new slave device is discovered by the master module.

### Implementation Details—Sensor Discovery

In embodiments of the present invention, each slave module automatically detects any attached sensors and reports information about these sensors to the master module during the addressing (commissioning) process. The data reported for each sensor will include the sensor functional properties. Such properties might include, but are not limited to:
sensor type (e.g.: occupancy, photo);
sensor sub-type (e.g.: passive IR occupancy, micro phonic occupancy);
sensor property detection units (e.g.: lumens, ft-candles);
sensor minimum and maximum ranges;
sensor accuracy data;
sensor calibration data; and
sensor location data (e.g. global positioning satellite (GPS) parameters or what slave modules the sensor is near).

In embodiments of the present invention, a slave module is capable of detecting sensors in a variety of different ways dependent on the physical capabilities of the slave module or upon other hardware connected to it (e.g.: an intelligent ballast or driver that supports sensor parameters).

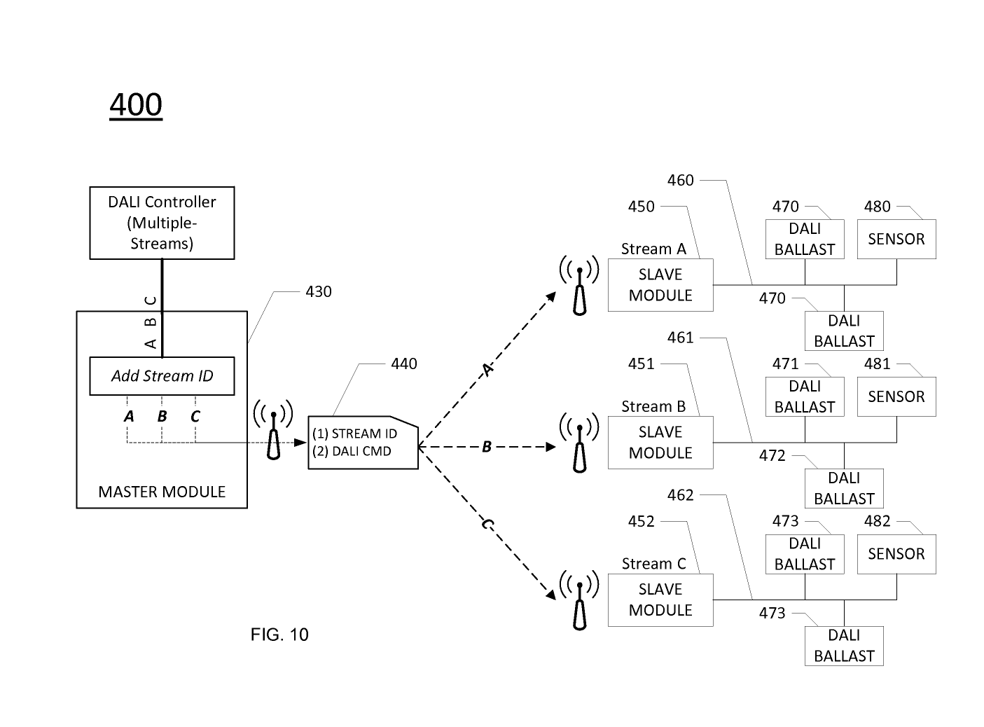

Referring to FIG. 10, as an example, consider a building control system 400 making use of DALI protocols with a master module 430 and multiple slave modules 450, 451, 452 each connected to multiple DALI slave devices 470, 471, 47, 472, 473 wherein a slave module 450 is connected to a sensor 480 using an advanced protocol, e.g. BACnet (building automation and control network), DALI 243-2004, and the like, which allows the slave module to issue commands and queries to the sensor 480. The slave module 450 may issue the commands or queries directly to the sensor 480 if it is communicating directly with the sensor 480 or in the case where another slave module 451 is communicating directly with the sensor 481 providing the sensor data and the first slave module 450 is not communicating directly with the sensor 481, the slave module 450 may communicate with the slave module 451 providing the sensor data if the slave module 450 issuing the commands is not directly communicating with the sensor 481. These commands may be used to ascertain information about the sensor itself.

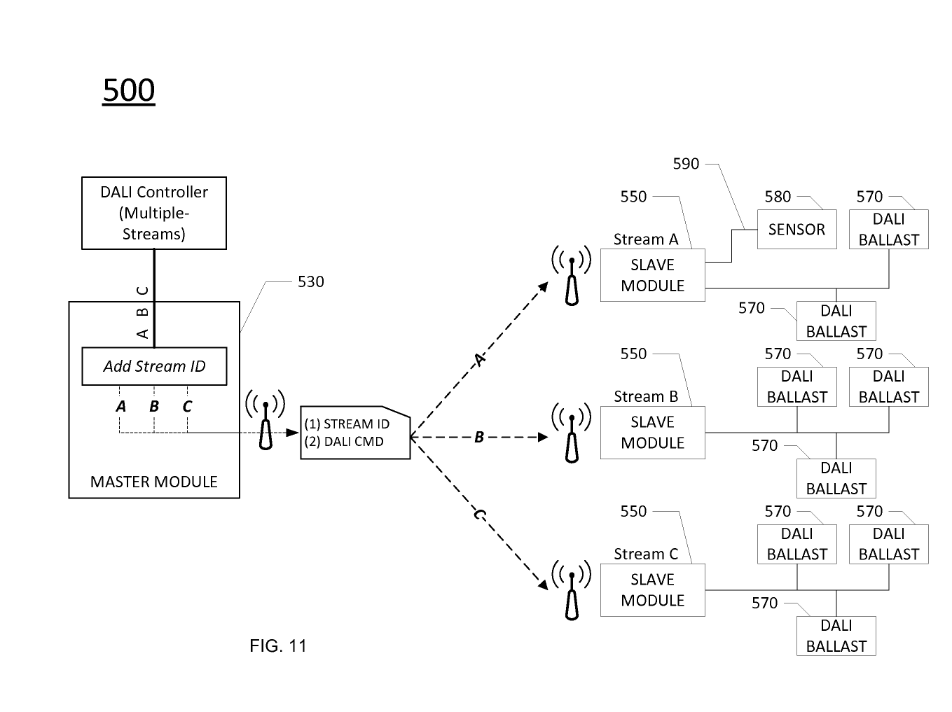

Referring to FIG. 11, as another example, consider a DALI system 500 with a master module 530 and multiple slave modules 550 each connected to multiple DALI slave devices 570 wherein a sensor 580 is connected to a slave module using a specialized connector 590. By utilizing the special connector 590 on the slave module 550 that provides a data input to the slave module 550 indicating whether or not a cable is plugged into the connector 590 allows for the basic presence of the sensor 580 to be automatically detected. In many lighting applications, an approach like this is sufficient to detect and provision a photo or occupancy sensor.

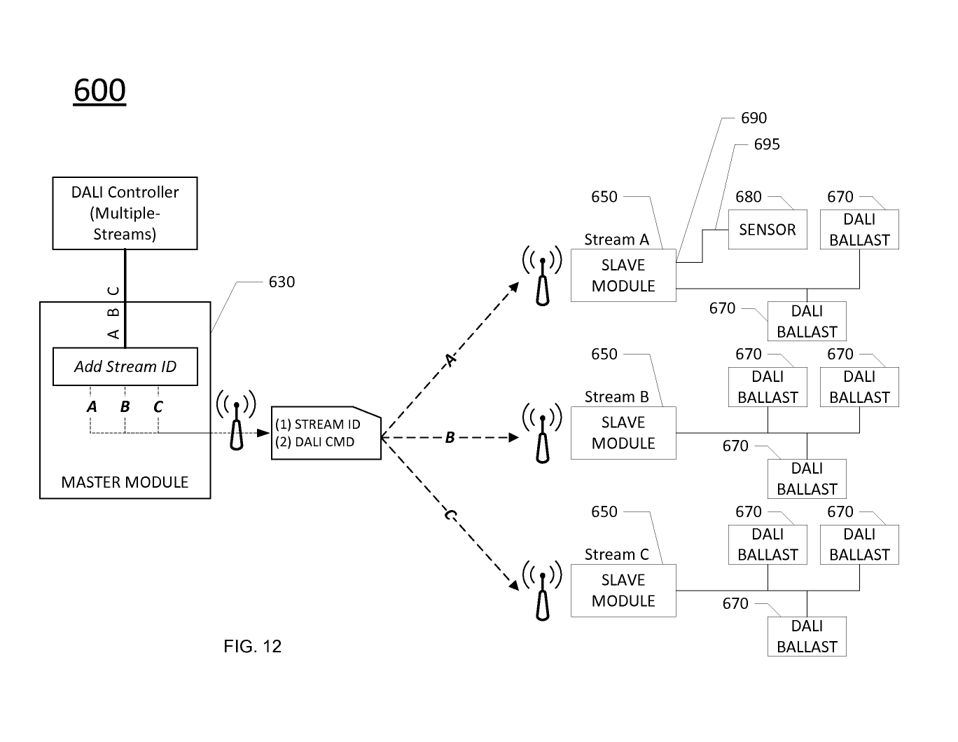

Referring to FIG. 12, as yet another example, consider a DALI system 600 with a master module 630 and multiple slave modules 650 each connected to multiple DALI slave devices 670 wherein a sensor 680 is connected to a slave module 670 using a specialized cable 695. This approach is identical to previous in architecture, but the data input comes from the sensor cable 695 as opposed to the connector 690 itself. The cable 695 attached to each sensor 680 may contain either active or passive electronics that can provide extensive or limited information, respectively, about the sensor 680. This approach is typically preferred over the prior example as in even its simplest form, it can provide far more information about the sensor 680 and is a less error prone, more scalable solution.

Specific techniques to implement this approach may include, but are not limited to:
raising or lowering a digital input by simply shorting two pins in the cable;
placing a resistor between two pins in the cable—and the actual resistance itself can be used to provide additional information on the type of sensor limited only by the accuracy of the resistor and ability to measure on the slave module; and
an active integrated circuit or some other advanced component that modulates a special signal over pins on the cable. This technique is more complicated but also offers options to pre-process the sensor data or provide other operations inline between the sensor and the slave module.

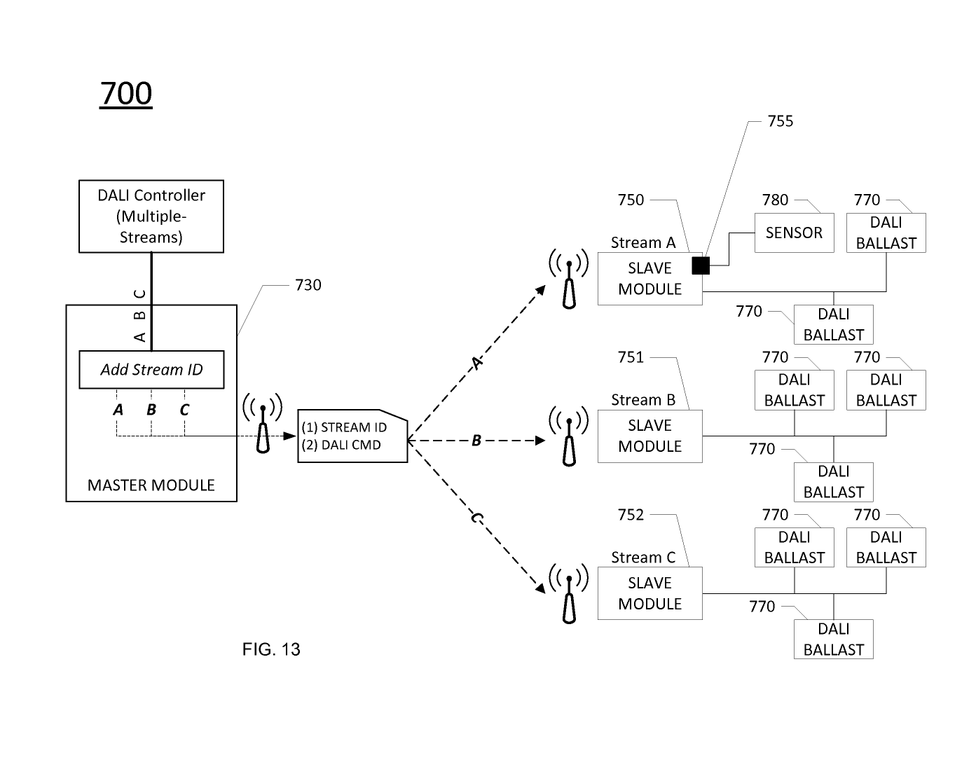

Referring to FIG. 13, as another example, consider a DALI system 700 with a master module 730 and multiple slave modules 750, 751, 752 each connected to multiple DALI slave devices 770 wherein a slave module 750 features a ‘switch’ to provide information about a sensor 780. In the simplest embodiment, a physical or virtual switch 755 can be used on the slave module 750 indicating information about a sensor 780. The switch could be set up via any of readily available techniques known to those skilled in the art; as an example, an installer could physically set a switch on the slave module 750 indicating that an occupancy sensor is installed. An alternative method of using the switch, the switch and related metadata could be provided via a software-based configuration pre-loaded on the slave module or configured on the slave module by a technician during the slave module installation or commissioning step. As those skilled in the art are aware several other techniques may be used to install and use the switch.

Unique to our system is not only the ability to automatically detect a sensor but to also provision the sensor on the master module. For an embodiment of the master module that supports actively managing a lighting control network, our system also includes the ability to provision any or all the slave modules on the master module and to thus dynamically configure the lighting control system parameters based on current and real-time sensor and data input availability on the network of slave modules. An example of this embodiment within the scope of an occupancy or photo sensor would allow an installer or electrician to physically move, add, or remove a sensor within the network and not have to make any other configuration adjustments or changes for the lighting control system to automatically and immediate incorporate the logical changes within the system.

### Implementation Details—Auto Configuration

Referring again to FIG. 10, and the representative embodiment of the present invention therein with the DALI system 400 with the master module 430 and multiple slave modules 450, 451, 452 each connected to multiple DALI slave devices 470, 471, 472, 473; when the master module 430 detects that a new DALI slave device 473 comes online, the master module 430 automatically dispatches configuration data to the DALI slave device 473 via the slave module 452 to ensure that the DALI slave device 473 configuration matches the site defaults. The configuration data is essentially a sequenced list of commands that is executed and verified on each connected DALI slave device 470, 471, 472, 473.

In a typical lighting environment, these configuration data will include items such as: minimum light level; maximum light level; power on light level; fade time; and fade rate.

The master module can re-configure slave modules at any time whenever the defaults are changed. The system intelligently conveys this configuration data to minimize system loading when multiple DALI slave devices come online at the same time. This occurs by: covering many configuration parameters in a single, streamlined data packet; caching the configuration data throughout the entire network of slave modules such that the data and commands only need to traverse a subset of the network to be disseminated to all connected devices; and managing what parameters need to be changed only dispatching commands required for system reliability and consistency. The auto configuration system is flexible and can support any configurable parameter on the DALI slave device. The parameters being configured can be changed at any time as well as having their default values changed via commands from an external control system (e.g. DALI controller using manufacturer specific commands or a BACnet control system) or via a configuration or management tool being used by a technician. Default parameters can be overridden for specific devices or omitted entirely, if required.

### Implementation Details—DALI Masquerade

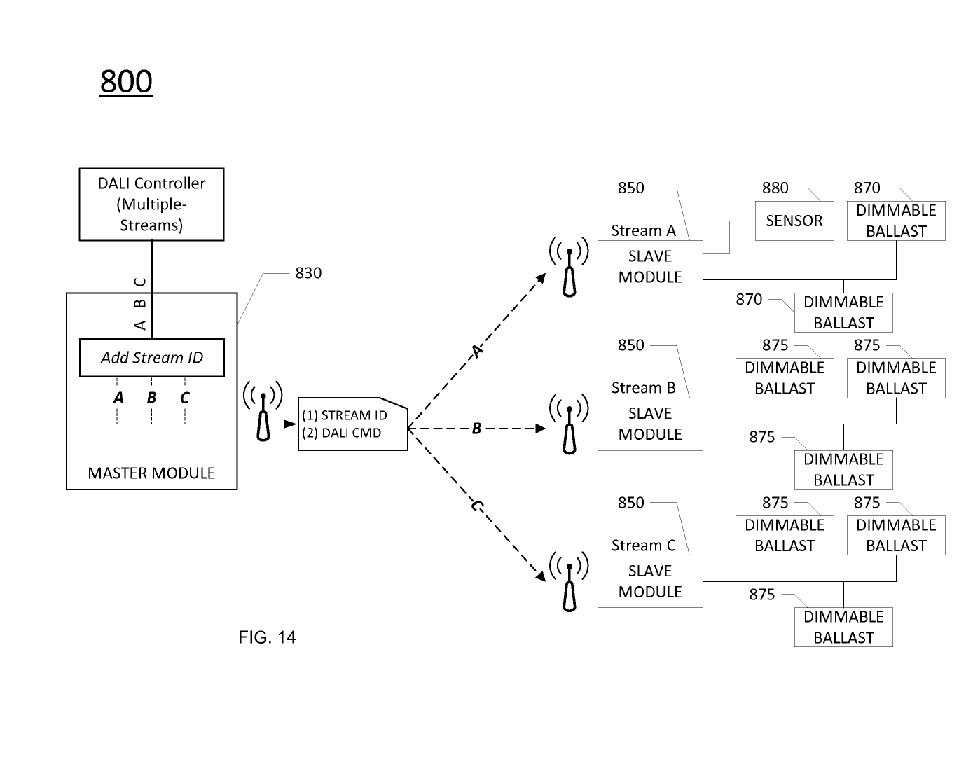

Referring to FIG. 14 and the representative embodiment depicted therein, with the DALI masquerade invention, slave modules can allow any dimmable lighting ballast or driver that can be physically connected to the module to behave like a DALI ballast. The slave modules respond to DALI commands based on internal state about the ballast. The slave modules take an arc power level and determine the corresponding light level and take whatever actions are required to set that level on the actual ballast or driver. The slave modules implement support for fade times, enforce min/max levels, and intelligently respond to errors. The slave modules support the incorporation of sensor data and other reserved DALI commands via a modular mechanism available for manufacturer specific extensions.

### Implementation Details—Non-Standard DALI Systems

The present invention can also be implemented in systems that follow non-standard DALI control schemes such as systems where the communication medium between a master module and a slave module requires state and/or dynamic addressing itself. An example of such a system is one using the ZigBee communication protocol. Complex situations can arise if this dynamic state is not persistent on the slave module or if an error occurs causing the slave module to reset. The present invention has capabilities to address these situations. Referring again to FIGS. 3 and 6, when a slave module sends an address request message (step 1530) to the master module, the slave module transmits a unique hardware identifier along with the address request message. The master module tracks the unique hardware identifier and DALI address for each slave device in the network in a data store and can thereby identify if a request for a DALI address is unique (step 1020). The master module can also determine whether a duplicate address request is from a slave device on the slave module which sent the original address request or if the address request is from another slave module in the system (step 1090).

Referring again to FIG. 10, and the representative embodiment of the present invention 400 depicted therein, the present invention also creates and exchanges metadata 440 between modules, or any slave module 450, 451, 452 or master module 430 sharing communications with one another. This metadata 440 contains installation parameters, such as if the module was configured as a replacement for an existing module in the system. The metadata 440 also includes the hardware serial numbers and can be expanded with slave module 450, 451, 452 specific data such as ballast 470, 471, 472, 473, or sensor 480, 481, 482 serial or model numbers as well. This multitude of metadata 440 allows each slave module 450, 451, 452 to have an awareness of its context within the system 400. In the case where a slave module 451 is replaced the new replacement slave module uses this metadata 440 to tell the master module 430 that it is replacing the previous unit. Because the master module 430 is thus aware that the slave devices attached 471, 472 to the new slave module are the same slave devices the master module 430 does not change those slave device 471, 472 DALI short addresses.

In the present invention, the system centralizes all data elements on the single master module 430 as opposed to distributing the data amongst slave modules 450, 451, 452. The slave modules 450, 451, 452 have the DALI specific capabilities and discovery elements. This partitioning of data and functionality minimizes the disruption to the system 400 in cases where a significant number of slave module failures or errors or device failures or errors occur and also improves scalability and commercialization by allowing for lightweight slave modules to be deployed.

The present invention allows for the master module 430 to handle slave module requests for addresses beyond the DALI specified limit of 64 addresses. The master module 430 can be readily configured to either allow the additional address request or create a secondary virtual DALI stream.

If the master module 430 is configured to approve the new address request regardless of it causing the system 400 to exceed the 64 DALI device limit, the system will treat this as a normal DALI system would handle an additional ballast added to the system 400. At least one DALI short address will control two or more slave devices as if they were a single device. This is identical to attaching more than 64-ballasts to a single DALI stream directly to a DALI controller.

If the master module 400 is configured to create a secondary virtual DALI stream upon request for a sixty fifth DALI slave device then the system will essentially consist of two or more DALI streams each with a namespace for DALI short addresses. This secondary virtual DALI stream may be accomplished using the techniques described in U.S. patent application Ser. No. 13/666,261 by Yeh and Sheehan. U.S. patent application Ser. No. 13/666,261 is hereby incorporated by reference in its entirety. Alternatively, the master module may be connected to multiple DALI controllers via a multiplicity of physical DALI streams.

The present invention also allows for the reservation of classes of DALI addresses and ranges of DALI addresses on the master module. Classes or ranges of DALI addresses can be reserved on the master module. This can aid in certain deployments where DALI slave devices are pre-configured with addresses that cannot be changed due to deployment constraints (e.g.: a DALI slave device that is hard wired with a sensor) or a DALI slave address that doesn't support having its address changed.

The present invention allows for any DALI slave device that is not in the approved state on both master and slave modules to still receive DALI broadcast and DALI group messages. This allows for DALI slave devices that are unable to have their address changed and for DALI slave devices that have an address that is duplicated within the system to still be controlled in a global fashion, e.g. if the master module sends a command to turn on all ballasts in a particular zone then all ballasts within that zone will turn on regardless of whether their status is approved or not.

The present invention can remain operational even when all available DALI short addresses become unavailable due to a problematic slave module or DALI slave device. The master module maintains several communication parameters for all slave modules and DALI slave devices and dynamically adjusts its sensitivity to these parameters to determine when to remove a non-communicating DALI slave device thus opening a new address to become available to other devices. These parameters and sensitivity incorporate protocol-specific attributes such as wireless performance (in the case of a wireless intermediate protocol); computed attributes such as module health status, communication latency, average/min/max communication latency; and other available parameters and data points to dynamically determine behavior. The extent and scope of these dynamic adjustments vary based on the specific protocols, hardware and system computational resources, and abilities of the slave and master modules. However, one common level of dynamic adjustment, as an example, would prevent the removal of a slave device address approval if it currently has not been communicating for a duration of time less than the average duration of time between communication errors since the slave device was originally commissioned. Adaptations like this allow this invention to work with slave devices and modules that are not persistently online or powered without adverse effects.

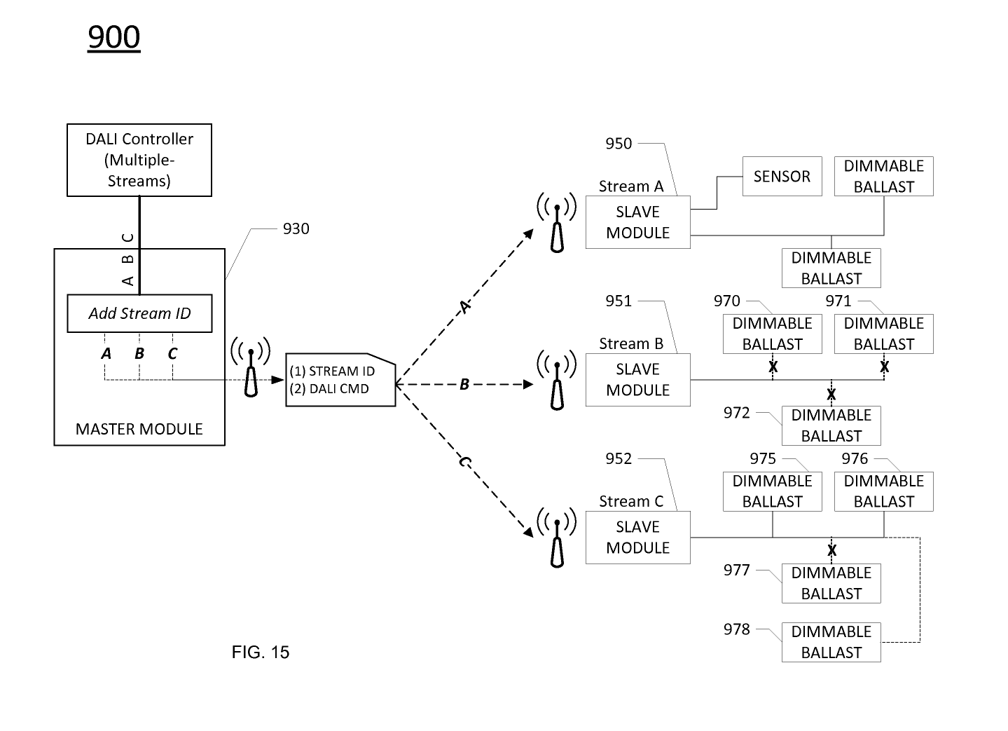

Referring to FIG. 15 and the representative example depicted therein, consider a DALI system 900 with a master module 930 and multiple slave modules 950, 951, 952 each connected to multiple DALI slave devices 970, 971, 972, 975, 976, 977 wherein a slave module 952 has one DALI slave device 977 that loses communication at the same time that a new DALI slave device 978 is discovered on the same slave module 952. This scenario is indicative of a DALI slave device replacement. In this case, the master module 930 will utilize abbreviated downtime expirations for the old slave device 977 and attempt to assign the same short address to the newly discovered slave device 978 attached to the same slave module 952.

Referring again to FIG. 15, as a further example, consider the DALI system 900 with a master module 930 and multiple slave modules 950, 951, 952 each connected to multiple DALI slave devices 970, 971, 972, 975, 976, 977, 978 wherein a slave module 950 and all DALI slave devices 970, 971, 972 attached to the slave module 950 all lose communication at essentially the same time. This scenario typically utilizes standard expiration times for the DALI slave devices 970, 971, 972 due to the variety of underlying problems that may be causing this and thus the inability to tune behavior based on scenario-specific characteristics available to other scenarios. As there is little information or insight as to the underlying problem causing the previously described symptoms, there is a need to revert to the baseline case to mitigate. If new addresses are needed under this scenario, the master module 930 will typically try to obtain as many of these new addresses as possible from a single non-communicating slave module 950 to minimize the scope of the impact (i.e., duplicate DALI short addresses within the system) should some of the non-communicating DALI slave devices 970, 971, 972 return to operation.

If a new slave module (not depicted) that appears to be new to the master module 930 (even if a replacement flag, indicating to the master module 930 that the slave module is new, has not been set) later comes online, then the master module 930 may elect to approve the new slave module's addresses if they match those approved under the previous slave module 950 exactly. This provides insurance that the short addresses within the system don't change in a replacement scenario.

As a further example, consider a DALI system with a master module and multiple slave modules each connected to multiple DALI slave devices wherein a slave module is communicating but one DALI slave module reporting to that slave device is no longer communicating. This scenario is typical of a DALI slave device failure. That the slave module is communicating is indicative that power is typically ok at the fixture itself and replacing the non-communicating DALI slave device will correct the problem. Since the remedy is replacement of the DALI slave device, the master module will retain the short address as long as there are other available short addresses for when additional slave devices get added to the system; this will enable the system to provide the replacement slave device the same short address of the original (and now defective) DALI slave device.

As yet a further example, consider a DALI system with a master module and multiple slave modules each connected to multiple DALI slave devices wherein a single slave module has requested a significant quantity of DALI addresses in an excessively short of a period. A significant quantity is determined dynamically based on the number of DALI controllers attached to the master module, the number of slave modules on the network, and thus the relative percentage of DALI addresses sought by a single slave module in proportion to these figures. This quantity essentially prevents a single Slave Module from monopolizing the majority of available DALI addresses on the stream(s). This is further adjusted based on slave module's hardware and software versions and capability discovery that occurs when it first connects to the master module. This latter provision is based on the physical hardware and software limitations of the slave module prohibiting it from grabbing more DALI addresses than the slave module version would otherwise be able to support.

The master module will assign DALI short addresses, if the slave devices in question have not already been assigned short addresses, which are associated with this slave module but the short addresses are assigned very short expiration times and the short addresses are assigned to be the first to be selected for removal if additional short addresses are required. These expiration times are based on the percentage of remaining DALI short addresses available on the master module DALI controller stream(s) and the rate at which additional slave modules are connecting to the system. If the short-term (i.e.: 5-minute) average slave module ballast request rate is such that the total available addresses would run out within x-minutes, the expiration time would typically be set for these potentially problematic addresses to just short of x-minutes.

If the slave module provided discovery data to the master module, the master module will further restrict and preemptively delete any short address allocations beyond what the slave module is capable of accommodating.

As a final example, consider a DALI system with a master module and multiple slave modules each connected to multiple DALI slave devices wherein a slave module only supports a given quantity of DALI slave devices, the master module will restrict the slave module to no more than that given quantity of DALI short address allocations. For example, if the slave module can only support 10 DALI slave devices, the master module will restrict the slave module to no more than 10 DALI short address allocations even if the slave module requests additional DALI short addresses.

Although several embodiments of the present invention, methods to use said, and its advantages have been described in detail, it should be understood that various changes, substitutions and alterations can be made herein without departing from the spirit and scope of the invention as defined by the appended claims. The various embodiments used to describe the principles of the present invention are by way of illustration only and should not be construed in any way to limit the scope of the invention. Those skilled in the art will understand that the principles of the present invention may be implemented in any suitably arranged lighting system. Those skilled in the art will also understand that the principles of the present invention may be implemented in any suitably arranged building control system. Examples of such building control systems include but aren't limited to energy minimization systems; heating, ventilation, and air conditioning (HVAC) systems, building security systems, and the like.

We claim:

1. A DALI compatible lighting control system comprising:
a DALI controller;
a first two wire bus;
a master module;
at least one slave module;
at least one slave device;
and at least one lamp bank;
wherein each slave module identifies at least one of said slave devices and requests the master module to provide an address for the slave device;
said master module maintains a list of all addresses; and
said master module assigns a unique address for the slave device.

2. The DALI compatible lighting control system of claim 1 further comprising a second two wire bus wherein the master module and at least one slave module communicate via a wireless communication protocol.

3. The DALI compatible lighting control system of claim 2 wherein at least one slave device is a non-DALI compliant device.

4. The DALI compatible lighting control system of claim 3 wherein the non-DALI compliant slave device is connected to one of said slave modules; said slave module masquerades said slave device as a DALI compliant slave device.

5. The DALI compatible lighting control system of claim 1 further comprising at least one slave device newly installed on the system wherein the system automatically detects the newly installed slave device.

6. The DALI compatible lighting control system of claim 5 wherein the master module assigns a DALI short address to the newly installed slave device; said short address being unique to the newly installed slave device.

7. The DALI compatible lighting control system of claim 6 wherein configuration parameters for the newly installed slave device are automatically set.

8. The DALI compatible lighting control system of claim 1 wherein configuration of all slave devices are updated upon global reconfigurations of the DALI controller.

9. The DALI compatible lighting control system of claim 1 further comprising at least one sensor wherein the system automatically detects the sensor.

10. The DALI compatible lighting control system of claim 9 wherein the sensor is connected to one of the slave modules via a cable.

11. The DALI compatible lighting control system of claim 9 wherein the sensor is connected to one of the slave modules via a special connector.

12. A method for commissioning at least one slave device on a DALI lighting control system; the method comprising the steps of:
A slave module recognizing a slave device;
The slave module requesting an address from a master module;
The master module determining whether the requested address is unique within the DALI lighting control system; and Upon determining that the requested address is unique, the master module sending a message back to the slave module indicating that the address is approved.

13. A method for commissioning at least one sensor on a DALI lighting control system; the method comprising the steps of:
A slave module recognizing a sensor;
The slave module requesting an address from a master module;
The master module determining whether the requested address is unique within the DALI lighting control system; and
Upon determining that the requested address is unique, the master module sending a message back to the slave module indicating that the address is approved.
